(19) United States
(12) Patent Application Publication
(10) Pub. No.: US 2014/0279272 A1
(43) Pub. Date: Sep. 18, 2014

(54) Methods and Systems for Sorting Items That Are Received for Further Shipment

(71) Applicant: Zulily, Inc., Seattle, WA (US)

(72) Inventors: Trevor Mark Inman, Tacoma, WA (US); David McCormick Brown, Seattle, WA (US); Daniel Shiovitz, Seattle, WA (US); Melissa Cherie Denise Baird, Seattle, WA (US); Luke Friang, Sammamish, WA (US); Kristin Elisabeth Toth Smith, Sammamish, WA (US); Nok Ho, Seattle, WA (US); Bryan Haber, Lynnwood, WA (US)

(73) Assignee: Zulily, Inc., Seattle, WA (US)

(21) Appl. No.: 14/189,941

(22) Filed: Feb. 25, 2014

Related U.S. Application Data
(60) Provisional application No. 61/800,942, filed on Mar. 15, 2013.

(51) Int. Cl. G06Q 30/06

(52) U.S. Cl. CPC G06Q 30/0635
USPC 705/26.81

(57) ABSTRACT

A method of sorting items that are received for further shipment includes determining a first quantity of the items to be placed into a first tote and a second quantity of the items to be placed into a second tote. The first tote conveys the items to a first location for immediate shipping to a first set of customers who have ordered only the item. The second tote conveys the items to a second location for matching with different items before being shipped to a second set of customers who have ordered combinations of the item and one or more of the different items. In response to receipt of the items, a first quantity of the items is placed into the first tote in accordance with the determined first quantity, and a second quantity of the items is placed into the second tote in accordance with the determined second quantity.

### CROSS-REFERENCE TO RELATED APPLICATION

This application claims the benefit of U.S. Provisional Patent Application No. 61/800,942, filed Mar. 15, 2013, the disclosure of which is incorporated by reference herein in its entirety.

### FIELD

The present application pertains to methods and systems for sorting items that are received for further distribution, particularly items received at fulfillment centers for packaging and shipping to customers.

### BACKGROUND

Companies engaged in the mail order or catalog business and electronic commerce typically use centralized fulfillment centers for bringing items into inventory for later shipment to customers when orders for the items are received. Items available for purchase are typically stored in bins on a network of shelves in fulfillment centers. The items remain on the shelves until such time that a customer orders an item. Based on a customer's order, a picker locates and retrieves the purchased items from their respective storage bins and provides the items to a shipper for shipment to the customer. Depending on the size of the fulfillment center and the distribution of the purchased items throughout shelves of the fulfillment center, the process of picking the purchased items can require substantial time and physical effort.

Companies operating such fulfillment centers often stock their shelves based on predicted or forecasted demand. The items, however, are held on the shelves until a customer order is received. Procedures in such fulfillment centers for receiving items from vendors and managing an inventory of items can be inadequate for some business enterprises.

### SUMMARY

The following summary is provided to introduce a selection of concepts in a simplified form that are further described below in the Detailed Description. This summary is not intended to identify key features of the claimed subject matter, nor is it intended to be used as an aid in determining the scope of the claimed subject matter.

Described herein are methods and systems for improving fulfillment center processes, particularly for sorting items received from vendors, for business enterprises that first obtain customer orders for items, and then seek to fulfill the orders for those items. For such business enterprises, customer orders for items presently exist at the time the vendors of the items deliver their products to the fulfillment center. The systems and methods disclosed herein include features in which some received items are never brought into inventory and stored on shelves in the fulfillment center for later picking by a picker. Rather, sorting procedures are used to send items from the receiving dock directly to package and shipping stations at the fulfillment center. For some items, the sorting procedures further direct items to areas of the fulfillment center for matching with other items ordered by customers for consolidated shipping. Remaining items received from vendors that are not subject to existing customer orders may be directed to other areas in the fulfillment center for longer-term storage. The sorting procedures described herein provide improved handling of items coming into the fulfillment center and, in some cases, lead to faster shipping of items to customers.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic diagram of a sorting procedure conducted in accordance with the present disclosure;

FIG. 2 is a flow diagram of a sales and purchase order process;

FIG. 3 is a flow diagram of a process for calculating sort quantities in accordance with the present disclosure; and

FIG. 4 is a flow diagram of a receive sort process in accordance with the present disclosure.

### DETAILED DESCRIPTION

FIG. 1 pictorially describes a sorting process 10 conducted in accordance with the present disclosure. As illustrated, a truck 12 containing items ordered from a vendor is received at a fulfillment center. The items in the truck are typically unpacked and carried into the fulfillment center in a variety of boxes or totes 14. The incoming totes 14 are directed to a receiving station 16.

Unlike traditional systems that merely receive items and place them in bins on shelves until such time that orders for the items are received, systems using the sorting process 10 are most improved when the items received from the truck 12 are already subject to existing customer orders. Rather than place all of the received items on shelves in the fulfillment center and later require pickers to retrieve the items for shipping, the sorting procedure 10 identifies quantities of the received items that can be immediately sent for shipping, as well as other quantities of items that can be held temporarily for matching with other items ordered by customers. By arranging for some items to be immediately shipped, there is reduced handling of the item since the item is not placed on a shelf only to be later retrieved for shipping. In such cases, customers may receive their ordered items sooner.

As described below in greater detail, receivers are persons at the fulfillment center who process incoming items, e.g., items received from vendors who ship their products to the fulfillment center using trucks 12. As the items are brought into the fulfillment center in the incoming totes 14, the receivers sort the items into multiple processing totes T1, T2, T3. As will be described below in greater detail, items in tote T1 are directed (i.e., conveyed) to a first location (e.g., a packing station) 18 for immediate shipping. Items in tote T2 are conveyed to a second location (e.g., an area) 20 of the fulfillment center where they are temporarily held for matching up with other items already ordered by customers, for consolidated shipping to the customers. Remaining items received at the receiving station 16 that are not subject to existing customer orders, and therefore are not sorted in either of the totes T1 or T2, may be considered “overstock.” Such items are placed in tote T3 and directed to a third location (e.g., longer-term storage shelves) 22, to be held as inventory. As used herein, the phrase “immediate shipping” refers to actions taken in close time proximity to receipt of the items for shipping of the items to customers. The term “immediate” does not preclude a short amount of time delay between receipt of the items and packaging of the items for shipment to the customers. The term “tote” is also nonlimiting and, according to various embodiments, should be interpreted as encompassing any structure configured to convey the received items to designated locations. Generally, the area 20 for matching items already ordered by customers is strategically located closer to the packing and shipping areas than the longer-term storage shelves 22, which may be located farther back in the fulfillment center.

In accordance with the present disclosure, receivers at the receiving station 16 are regularly provided information to know how many items of each type of product received in the incoming totes 14 should be placed into the respective totes T1, T2, or T3 when the items are received. Accordingly, when items are received at the fulfillment center, the receivers can efficiently unpack the incoming items and quickly identify into which of the totes T1, T2, or T3 the items should be placed.

Turning to FIG. 2, a sales and purchase order process 40 is illustrated. The process 40 begins with one or more sales events becoming active, as indicated at block 42, wherein items are made available to customers for purchase. While the sales events are active, orders for the items may be received from customers, as indicated at block 44. As customer orders are received, the quantity of items ordered by the customers may periodically be aggregated and ordered from a vendor. Typically, a purchase order for the items is generated and sent to the item vendor, as indicated at block 46. While the sales events remain active, additional customer orders may be received, as indicated by process arrow 48. In such cases, one or more additional purchase orders for later-ordered items may be generated and sent to the item vendor.

Upon receipt of the one or more purchase orders, the vendor assembles the ordered items, typically into one or more bundles, boxes, or bins, and arranges for shipping of the items to the fulfillment center. Trucks, such as truck 12 shown in FIG. 1, arrive at the fulfillment center with the ordered items, at which time the receivers operating the receiving station 16 unpack the received items.

To ensure that the receivers properly sort the received items into the appropriate totes T1, T2, or T3 as described herein, it is necessary that the receivers be informed of the quantity of each item that should be placed in the respective totes. FIG. 3 illustrates a method in which sort quantities are calculated and sent to the receiving station 16 for use by the receivers in sorting incoming items.

The process 60 illustrated in FIG. 3 begins at block 62 wherein a sort quantity calculator receives information concerning customer orders, e.g., as placed in block 44 of FIG. 2. In various implementations, the sort quantity calculator is a software process operating on computing equipment and is configured with computer-executable instructions that cause the computing equipment to receive, process, and communicate information with other software processes. In at least one embodiment, the customer order information received by the sort quantity calculator includes information identifying the quantity of each item that is subject to customer orders for only a single item (i.e., a single-item order). The customer order information received by the sort quantity calculator also includes information identifying the quantity of each item that is subject to customer orders for multiple items.

The customer order information for each item in each category (single-item and multi-item orders) is aggregated and stored for later retrieval. Such information may be stored in a table or any form of database in a computer memory. The stored information is later used to guide receivers at the fulfillment center on how to process incoming items received from vendors. Items may be received at the fulfillment center from different vendors at different times.

At block 64, the sort quantity calculator uses the customer order information stored in the memory to calculate “sort quantities” for each item that customers have ordered. In some embodiments, the calculations at block 64 simply comprise an aggregation of information regarding the quantity of each item ordered in single-item and multi-item orders. Sort quantities calculated by the sort quantity calculator ultimately inform receivers in the fulfillment center regarding the amount of each item, when received, to direct into the totes T1, T2, and T3.

In other embodiments, the calculations conducted at block 64 may be more complex. For example, it may be desirable to consolidate shipping to customers who order different items. When purchase orders are placed with vendors, estimated dates for receiving the items at the fulfillment center may be determined. Based on the expected dates for vendor items to arrive at the fulfillment center, the receive sort calculator may, for example, determine whether a greater quantity of items received in a first shipment may be allocated to tote T1 in view of additional time that is needed for items to be received in later shipments and matched with other items using tote T2. Coordinating the estimated receipt times among different vendors with estimated customer delivery times and calculating the sort quantities discussed above based on the timing information improves the ability to consolidate shipping for customers who have ordered multiple items.

As one illustrative example of the process described above, during a sales event, customers may have placed orders to purchase items A, B, and C, which are offered, respectively, by vendors X, Y, and Z. Some customers may have ordered only a single item, such item A, while other customers may have ordered combinations of A, B, and/or C. In this example, circumstances may be such that 300 total units of item A were ordered during the sales event, of which 150 units were ordered by customers making only a single item purchase of item A and the remaining 150 units were ordered by customers who purchased items B and/or C along with item A. Suppose that customers who purchased both items A and B together ordered, in the aggregate, a total of 25 units of item A.

As a result of purchase orders placed with the vendors X, Y, and Z, vendor X begins by shipping 100 units of item A to the fulfillment center, while vendor Y ships a number of units of item B, and vendor Z ships a number of units of item C. The shipment from vendor X is expected to arrive at the fulfillment center on July 1, while the shipment from vendor Y is expected to arrive on July 2, and the shipment from vendor Z is expected to arrive on July 8.

In anticipation of the shipment from vendor X and depending on the configuration of the receive sort calculator, the receivers at the fulfillment center may be directed to place 75 units of item A, when received, into the tote T1 for immediate shipping to customers who placed single-item orders, and 25 units of item A into the tote T2 for matching with items B to be received the following day. Because item C is not expected to be received until many days later, the receive sort calculator may be configured such that it does not direct the receivers to place any units of item A into the tote T2 for matching with items C. Instead, the receive sort calculator delays allocating any quantities of item A for matching with item C until a shipment is received from vendor X that is closer in time to the expected receipt date of item C.

If circumstances had been such that the shipments from vendors Y and Z were both expected to be received at the fulfillment center much later than the shipment from vendor X, the receive sort calculator may instead have allocated all 100 units of item A to the tote T1 for immediate shipping to customers who placed the single-item orders.

In other circumstances, during or after the sales event, customers may have been informed of different expected delivery dates of their purchases. The receive sort calculator may be configured to allocate units of received items A, B, and C into the totes T1 and T2 to best fulfill the delivery dates promised to the customers. In yet other embodiments, the receive sort calculator may be configured to take into account both promised delivery dates and expected shipment receive dates from the vendors X, Y, and Z to allocate quantities of items A, B, and C into the totes T1 and T2.

Once the sort quantity calculator at block 64 has calculated sort quantities for each incoming item, the sort quantities are stored in memory and eventually communicated to the fulfillment center, as indicated at block 66. In this manner, receivers at the receiving station 16 are provided with the sort quantity information so they will be able to efficiently sort the incoming items when the items are received. Incoming items are unpacked and placed into the totes T1, T2, and T3 based on the calculated sort quantities for each item.

FIG. 4 illustrates an embodiment of a sorting procedure 80 that may be used by receivers at the receiving station 16 shown in FIG. 1. Portions of the sorting procedure 80 are typically implemented by computer-executable program instructions operating on computing devices within the fulfillment center.

As indicated at block 82, a receiver may begin by preparing three empty sorting totes T1, T2, and T3. Preferably, each of the sorting totes is uniquely identified by a scannable identification. Similarly, the incoming totes 14 containing the items retrieved from the truck 12 are also identified by unique scannable identifiers.

At block 84, a receiver receives an incoming tote 14 from the truck 12 and scans the unique identifier of the tote 14. At block 86, the receiver retrieves an item or a bundle of items from the tote 14. The item or bundle of items is also identified by a scannable identifier. For example, the scannable identifier on an item may represent a stock-keeping unit, or “SKU,” for the particular item. At block 86, the receiver scans the identifier of the retrieved item.

At this stage, computing devices within the fulfillment center conducting the sorting procedure 80 know the identification of the item that the receiver is currently handling. As indicated by block 90, the computing devices retrieve from memory the previously determined sort quantities for the item that were calculated at block 64 (FIG. 3).

At block 92, the computing devices display to the receiver the respective quantities of the item to be sorted into the totes T1, T2, and T3. At block 94, the receiver scans a unique identifier for the tote T1. As mentioned earlier, in various embodiments described herein, tote T1 is intended for items that satisfy single-item customer orders. Based on the sort quantity displayed for the tote T1, the receiver retrieves a quantity of the item from the incoming tote 14 and places the item quantity into the tote T1. At block 96, the receiver informs the sorting procedure 80 of the quantity of the item that was placed in the tote T1.

At this stage, as indicated by decision block 98, a determination is made whether additional quantities of the item remain in the incoming tote 14 to be sorted. For example, there may be an additional quantity of the item that should be placed in tote T2 for matching with other items, to satisfy multi-item customer orders. If there is an additional quantity of the item to sort, the receiver scans the next sorting tote (in this example, tote T2) and places a quantity of the item in the tote T2 in accordance with the sort quantity displayed to the receiver. At block 96, the receiver informs the sorting procedure 80 of the quantity of the item that was placed in the tote T2.

If there still remains an additional quantity of the item in the incoming tote 14 that has not been placed in either of the totes T1 or T2, the additional quantity of the item is directed to tote T3 to be put away in the fulfillment center as excess inventory or overstock. The receiver scans the sorting tote T3 as indicated at block 94, places the excess quantity of the items in the tote, and informs the sorting procedure 80 of the quantity of the item placed in the tote T3.

The foregoing process of scanning the sorting totes T1, T2, and T3, and placing a quantity of an item into the sorting totes in accordance with displayed sort quantity calculations is repeated until all units of the item have been sorted into the totes T1, T2, and T3. Once all of the units of an item have been placed in a proper tote, the sorting procedure 80 updates the item's sort quantity calculations and stores the updated information in the table, as indicated by block 100. The updated sort quantity calculations are then used by the receiver or other receivers when additional shipments of the item are retrieved from the truck 12.

At this stage, as indicated at decision block 102, a determination is made if additional items remain in the incoming tote 14 to be sorted. If so, the sorting procedure 80 returns to block 86 where the receiver retrieves an item or item bundle from the tote 14 and scans the unique identifier of the retrieved item. The item is then sorted and placed in the totes T1, T2, and T3 as described above, in accordance with the calculated sort quantities displayed by the sorting procedure 80.

In circumstances where an incoming tote 14 contains multiple different items, the sorting procedure 80 need not change because the receiver handling the incoming tote 14 scans each item or item bundle as they are retrieved from the incoming tote (block 86). As each retrieved item or item bundle is placed into a tote T1, T2, or T3 in accordance with a sort quantity displayed to the receiver, and the receiver confirms that the quantity of the item has been placed into the tote T1, T2, or T3 (block 96), the remaining sort quantity for the particular item may be updated (block 100). When the incoming tote 14 is empty, the sorting procedure 80 for the receiver concludes until the receiver receives a new tote 14 containing items to be sorted. The receiver may retrieve another incoming tote 14 from the truck 12. At this stage, the receiver begins operating the sorting procedure 80 and, as indicated at block 84, the receiver scans the unique identifier of the incoming tote 14. The receiver then begins processing the items contained in the incoming tote 14 in accordance with blocks 86-102 shown in FIG. 4.

The sorting procedure of the present disclosure has many advantages over current sort and receive procedures of existing fulfillment centers. One advantage is that certain quantities of items are sorted (e.g., into tote T1) for immediate packaging and shipping. The items placed in tote T1 are not placed onto shelves as inventory for later picking and shipping. Even the items that are placed into tote T2 are not put away into inventory for long-term storage. Rather, the items in tote T2 are only taken to a temporary holding area for matching with other items that may already be at the receiving dock or are soon to be received. In any event, the item is held in the matching area only for a short time until the multi-item customer orders are satisfied and the matched items are shipped.

Although embodiments in the foregoing description include three sorting totes T1, T2, and T3, other embodiments may have any number of sorting totes Tn, depending on the needs of the sorting process and the operation of the fulfillment center. In an embodiment, a fourth sorting tote T4 may, for example, be used to collect items to be sent to another fulfillment center for matching with items ordered by customers and being delivered to the other fulfillment center by the item vendors. Thus, consolidated customer shipping across multiple fulfillment centers may be more efficiently achieved.

While the various embodiments of the invention have been illustrated and described herein, it will be appreciated that various changes can be made without departing from the spirit and scope of the invention. The scope of the invention should therefore be determined from the following claims and equivalents thereof.

The embodiments of the invention in which an exclusive property or privilege is claimed are defined as follows:

1. A method of sorting items that are received for further shipment, the method comprising:
determining, by a computing device, a first quantity of the items to be placed into a first tote, wherein the first tote is configured to convey the first quantity of the items to a first location for immediate shipping to a first set of customers who have ordered only the item;
determining, by a computing device, a second quantity of the items to be placed into a second tote, wherein the second tote is configured to convey the second quantity of the items to a second location for matching with different items before being shipped to a second set of customers who have ordered combinations of the item and one or more of the different items; and
in response to receipt of the items:
selecting the first quantity of the items and placing the selected first quantity of the items into the first tote;
selecting the second quantity of the items and placing the selected second quantity of the items into the second tote; and
causing the first tote to be conveyed to the first location for immediate shipping of the first quantity of the items to the first set of customers.

2. The method of claim 1, further comprising causing the second tote to be conveyed to the second location for matching the second quantity of the items with the one or more of the different items before being shipped to the second set of customers.

3. The method of claim 2, wherein in response to matching the item with different items according to orders by the second set of customers, further causing the matched combinations of the item and different items to be conveyed to the first location for shipping to the respective customers in the second set of customers.

4. The method of claim 1, wherein the first quantity of the items is selected and placed into the first tote without entering the first quantity of the items into a storage inventory.

5. The method of claim 1, wherein the second quantity of the items is selected and placed into the second tote without entering the second quantity of the items into a storage inventory of items not subject to an existing customer order.

6. The method of claim 1, wherein the second quantity of the items is determined based at least on an expected date of receipt of the items and information regarding availability of the different items to be matched.

7. The method of claim 1, further comprising selecting and placing into a third tote any remaining quantity of the items not placed into the first tote or the second tote, wherein the third tote is configured to convey the items to a third location for longer-term storage.

8. The method of claim 7, further comprising entering the remaining quantity of the items into a storage inventory that is recorded in a computer-accessible memory.

9. A computing system configured to facilitate sorting of items that are received for further shipment, the system comprising:
computing equipment configured to operate in accordance with programmed software instructions; and
a memory coupled to the computing equipment, wherein the memory has computer-executable instructions stored therein that, in response to execution by the computing equipment, cause the computing equipment to:
receive customer order information identifying a quantity of an item that is subject to one or more single-item customer orders for only the item;
receive customer order information identifying a quantity of the item that is subject to one or more multi-item customer orders for combinations of the item and one or more different items;
store, in a database in the memory, the customer order information identifying the quantities of the item that are subject to customer orders;
receive vendor information that identifies an amount of the item that is being sent for sorting and further shipping to customers in accordance with the customer order information;
determine a first quantity of the item to be conveyed to a first location for immediate shipping in accordance with the one or more single-item customer orders when the amount of the item sent by the vendor is received;
determine a second quantity of the item to be conveyed to a second location for matching with different items in accordance with the one or more multi-item customer orders when the amount of the item sent by the vendor is received; and
communicate the determined first quantity and second quantity of the item to facilitate sorting of the items for conveyance to the first and second locations when the amount of the item sent by the vendor is received.

10. The system of claim 9, wherein the instructions further cause the computing equipment to display the communicated first and second quantities of the item for use when sorting the items received from the vendor.

11. The system of claim 9, wherein the second quantity of the item is determined based at least on an expected date of receipt of the amount of the item from the vendor and information regarding availability of the different items to be matched.

12. The system of claim 9, wherein the first quantity of the item is determined based at least on the customer order information identifying the quantity of the item that is subject to the one or more single-item customer orders for only the item.

13. The system of claim 9, wherein the first quantity and/or the second quantity of the item are determined based at least on information regarding promised dates of delivery of the item to customers.

14. The system of claim 9, wherein the first quantity and/or the second quantity of the item are determined based at least on an estimated date of receipt of the amount of the item from the vendor and estimated delivery date information from vendors of the different items to be matched.

15. The system of claim 9, wherein the instructions further cause the computing equipment to determine a remaining quantity of the item received from the vendor after the first and second quantities of the item have been sorted and enter the remaining quantity of the item into a storage inventory that is recorded in the memory.

16. The system of claim 9, wherein the determined first quantity and second quantity of the item are communicated to a fulfillment center that receives the amount of the item from the vendor, sorts the item according to the first and second quantities, and ships the item to the customers in accordance with the customer orders.

17. The system of claim 9, wherein the instructions further cause the computing equipment to update the information stored in the database in the memory regarding the quantities of the item still subject to outstanding customer orders after the first and second quantities of the item have been sorted.

18. A non-transitory, computer-readable medium having computer-executable instructions stored thereon, wherein the instructions, in response to execution by computing equipment, cause the computing equipment to:
receive customer order information identifying a first quantity of an item that is subject to one or more single-item customer orders for only the item and a second quantity of the item that is subject to one or more multi-item customer orders for combinations of the item and one or more different items;
receive information from a vendor of the item identifying an amount of the item that is being sent to a fulfillment center for sorting and further shipping of the item to customers in accordance with the customer order information;
communicate to the fulfillment center the first quantity of the item to be conveyed to a first location for immediate shipping in accordance with the one or more single-item customer orders when the amount of the item sent by the vendor is received; and
communicate to the fulfillment center the second quantity of the item to be conveyed to a second location for matching with different items in accordance with the one or more multi-item customer orders when the amount of the item sent by the vendor is received.

19. The non-transitory, computer-readable medium of claim 18, wherein the instructions cause the computing equipment to determine the first quantity and/or the second quantity of the item that is communicated to the fulfillment center based at least on information regarding promised dates of delivery of the item to customers.

20. The non-transitory, computer-readable medium of claim 18, wherein the instructions cause the computing equipment to determine the first quantity and/or the second quantity of the item that is communicated to the fulfillment center based at least on an estimated date of receipt of the amount of the item from the vendor and estimated delivery date information from vendors of the different items to be combined with the item.
